(19) United States
(12) Patent Application Publication
(10) Pub. No.: US 2022/0074775 A1
(43) Pub. Date: Mar. 10, 2022

(54) Dual Tube Hybrid Coriolis Mass Flow Sensor

(71) Applicant: Guanghua WU, McKinney, TX (US)

(72) Inventor: Guanghua WU, McKinney, TX (US)

(21) Appl. No.: 17/013,938

(22) Filed: Sep. 8, 2020

(51) Int. Cl. G01F 1/84; G01F 1/69

(52) U.S. Cl. CPC G01F 1/8422; G01F 1/69

(57) ABSTRACT

A sensor with both Coriolis tube and thermal tube is used to measure the mass flow rate of the fluid using both the Coriolis principle and the thermal method simultaneously. Above certain flow rate, the flow rate is measured by the Coriolis tube and below that flow rate, it is measured by the thermal tube. The Coriolis tube and the thermal tube are arranged parallelly with the common inlet and outlet. Two resistant coils are wound on the thermal tube to do the thermal measurement and a magnetic disk is attached to the Coriolis tube, work together with an excitation coil and two optical sensors to do the Coriolis flow measurement. It takes the advantages of both technologies and create a flow sensor which is super accurate, gas type insensitive, long-term stable and fast responsive without too much pressure drop.

### FIELD OF THE INVENTION

The present invention is related to a dual-tube mass flow sensor combining the technologies of the Coriolis flow measurement and the thermal flow measurement, specially targeting gas applications.

### BACKGROUND OF THE INVENTION

Coriolis flow sensors are based on the Coriolis principle, that is when a mass moving in a rotating system, Coriolis force will be produced. Coriolis flow sensor have many advantages:
Accurate—Coriolis technology measures the mass directly, typically the accuracy can reach ±0.2% (compare with ±1% for the thermal sensors);
Fluid insensitive—for the same reason, the mass is directly measured, no matter what fluid is flowing, or it is liquid or gas. It can easily switch from one medium to another medium without recalibration, all it needs is a density conversion;
Good range—the up limit of the flow range is basically up to the allowed pressure drop;
Fast response—the response time is in millisecond level;
Good long-term stability—theoretically, there is no measuring factor changing with the time;
Good linearity—the relationship between the sensor output and the flow rate is a perfect straight line. This makes the calibration very easy, most of the time, only one-point calibration will be enough.

Coriolis flow sensor also has its limitation, a major one is the difficulty to use them in gas applications stemmed from the low density of gases. For the Coriolis flow sensor, the signal strength is directly proportion to the mass flow rate. As gases have much low densities than liquids, for the same pressure drop, the Coriolis tube will flow much low mass flow rate, this will make the signal much weaker when flowing gases, especially at low end of the flow, the background noise will make the measurement impossible. The consequences are: first, the ranges of gas applications are much narrower; another one is the minimum detectable mass flow rate or resolution is not low enough. For liquid applications, the turn-down ratio of the Coriolis sensor can easily reach to 200:1, but for gas applications, it will be difficult to reach to a 50:1 turn-down ratio. In many cases, especially for lighter gases, it can only reach 20:1 turn-down ratio or worse.

### SUMMARY OF THE INVENTION

To solve the issues of using the Coriolis technology in gas applications, the thermal flow measurement technology is included in this invention.

Thermal mass flow measurement is based on the thermal cooling effect of the flowing fluid. They usually use one or more heated sensing element(s), placed in the vicinity or inside of the flow path, by measuring the temperature change of the element(s) caused by cooler fluid to decide the flow rate. The major advantages of thermal flow sensors are:
high sensitivity—this technology can detect very subtle flow;
low pressure drops—during measuring, the pressure drops of the flow tube carrying fluid is low.

In this invention, a thermal measurement tube is arranged in parallel with the Coriolis tube. In the low flow end, such as below 10%, the thermal measurement will take over. In this way, the flow sensor will keep all the benefits of Coriolis measurement, but compensated the shortcoming of it at the low flow end.

In the thermal tube, two coils are wound on it and they are heated by the currents flow through, by measuring the temperature changes brought by the flow, the flow rate can be measured. The calibration of the thermal measurement will be based on the Coriolis measurement, so all the benefits of Coriolis measurement will be kept. The results from the thermal measurement will be combined with the Coriolis measurement results to cover the whole flow range.

### BRIEF DESCRIPTION OF THE DRAWINGS

FIG. 1 is a perspective view of one embodiment of this invention.

FIG. 2A is a perspective view of the thermal tube without sensor cover; FIG. 2B. is the thermal tube in the middle step of installing the sensor cover and FIG. 2C is the thermal tube with cover installed.

FIG. 3 is a section view showing the installation of both the Coriolis tube and the thermal tube.

FIG. 4 is a chart showing the relationship between the flow rate and the pressure drop of the Coriolis tube of one of the embodiments flowing water.

FIG. 5 is a chart showing the relationship between the flow rate and the pressure drop of the Coriolis tube of one of the embodiments flowing Nitrogen.

FIG. 6 is a chart showing the relationship between the flow rate and the pressure drop of the thermal tube of one of the embodiments flowing Nitrogen.

FIG. 7 is a sketch showing the exemplary wiring of the thermal coils.

FIG. 8A is a chart showing the average temperature distribution of the thermal tube wall without flow; FIG. 8B is a chart showing the average temperature distribution of the thermal tube wall with flow.

FIG. 9 is a chart showing the average temperatures of the coils with the flow rate increasing.

FIG. 10 is a chart showing the average resistances of the coils with the flow rate increasing.

FIG. 11 is a chart showing the voltage outputs of the coils with the flow rate increasing.

FIG. 12 is a chart showing the flow rates by the Coriolis tube, thermal tube and the total flow rate.

### DETAILED DESCRIPTION OF THE INVENTION

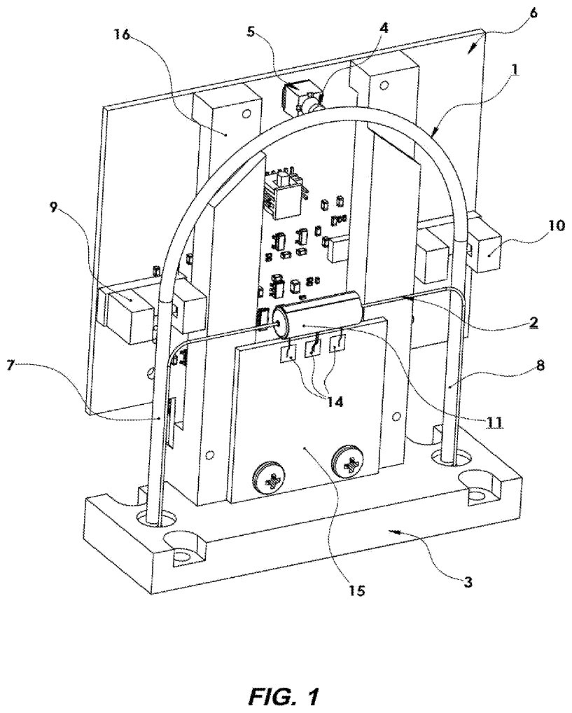

FIG. 1 is a perspective view of one of the embodiments of this invention. Coriolis tube 1 and thermal tube 2 are mounted on the sensor base 3 by means of laser welding and brazing. On Coriolis tube 1, a magnet disk 4 is attached. A coil 5 on the Coriolis PCB 6 will drive Coriolis tube 1 through magnet disk 4 to a swing vibration with the resonant frequency of the tube. This vibration will produce a periodical force acting on its upstream leg 7 and downstream leg 8. The directions of this pair of forces are opposite with each other, and they will twist the two legs around its central vertical axis periodically with a frequency equal to its swing frequency. Two optical sensors 9 and 10 mounted on Coriolis PCB 6 are used to measure the phase difference between upstream leg 9 and downstream leg 10. The phase difference will be an indication of the flow rate running through the tube.

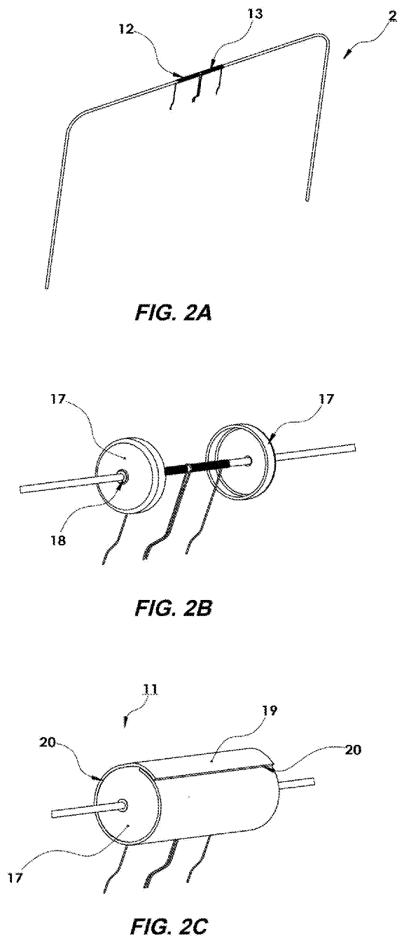

Thermal tube 2 has a cover 11 in the middle of its top horizontal beam. Inside cover 11, there are two coils 12 and 13 wound on thermal tube 2 (FIG. 2A). Four leads will be spot-welded or soldered to the connection pads 14 on thermal PCB 15 with two middle leads shared the same pad. Sensor PCB mount 16, on which both Coriolis PCB 6 and thermal PCB 15 are mounted, is mounted on sensor base 3. The whole sensor will be mounted to the base of a mass flow meter or a mass flow controller (not shown here) at the four mounting counterbores.

FIG. 2A is the perspective view of thermal tube 2 without sensor cover on. In this embodiment, the sensor tube is made of 316L, has an internal diameter 0.01″ (0.254 [mm]) and a wall thickness 0.0025″ (0.0635 [mm]), the whole length of the tube is 140 [mm]. The width of each coil is 3.5 [mm] and the gap between the two coils is 0.5 mm. The coils are wound with Balco, a Ni—Fe alloy wire, which has a temperature coefficient 0.0045 [1/K], with a diameter 0.0006″ (0.015 [mm]). The resistance of each coil at the room temperature is 308 [Ω].

To create a stable thermal environment, cover 11 made of copper sheet is installed. FIG. 2B shows the first step of the installation of the cover. Two end pieces 17 are soldered to the tube on two sides of the coils at 18. FIG. 2C shows the next step that a sheet of copper 19 has been wrapped and soldered at 20 to the end pieces 17. Cover piece 19 has three holes to let the lead wires of the coils go through (not shown in FIG. 2C).

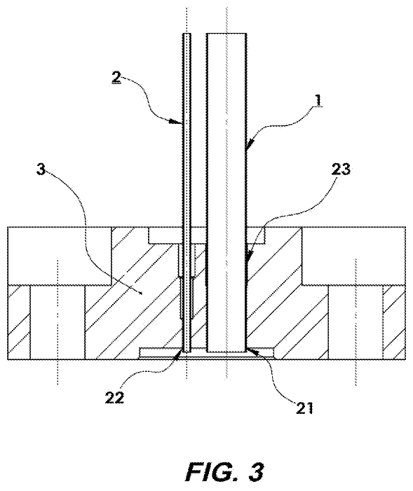

FIG. 3 shows how both Coriolis tube 1 and thermal tube 2 are mounted.

They are laser-welded to sensor base 3 at 21 and 22. For Coriolis tube 1, to strengthen the connection and provide a stable support, it will be brazed at 23.

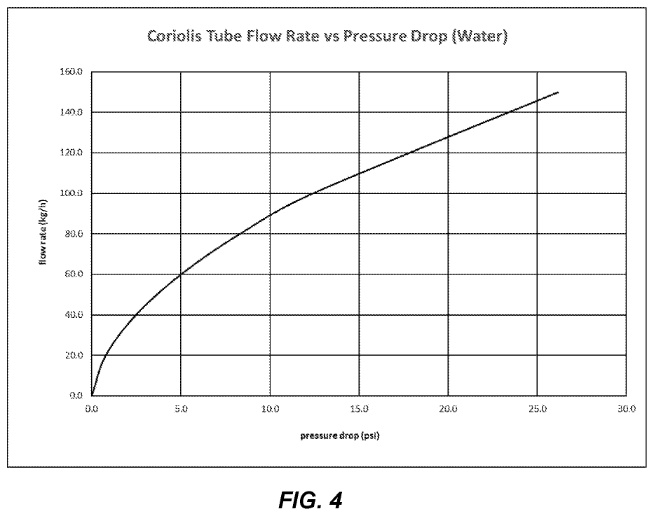

In this embodiment, Coriolis tube 1 is made of 316L with an ID 2.286 [mm], OD 2.413 [mm] and 194 [mm] long. With a pressure drop 14.7 [psi], the full flow rate for water is close to 110 [kg/h]. FIG. 4 shows the relationship between the flow rate and the pressure drop for flowing water.

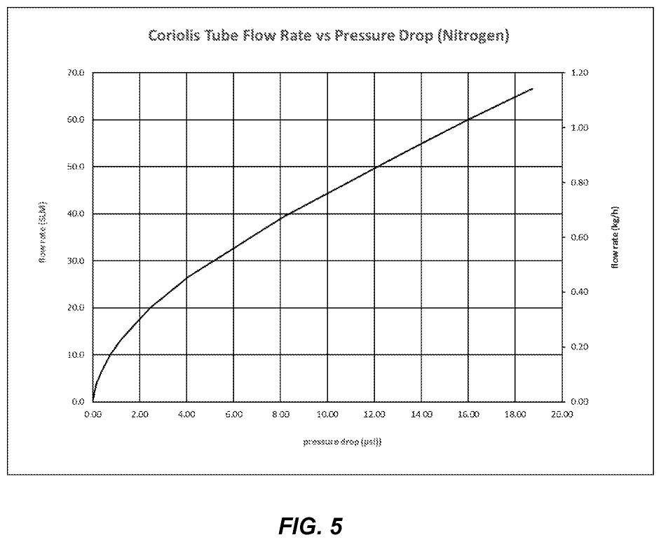

When flowing Nitrogen, the flow rate under 14.7 [psi] pressure drop is about 1 [kg/h], or 57 [SLM], which is shown on FIG. 5. We will take 50 [SLM] as the full flow rate.

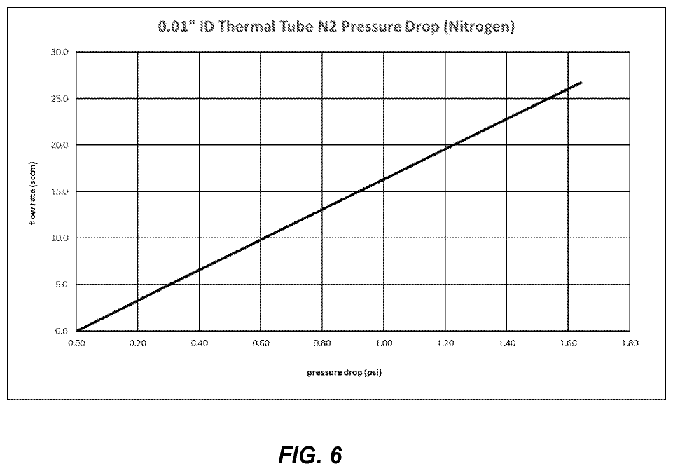

Depend on the gas and other factors, when the flow rate below certain percentage of the full flow rate (here is 50 [SLM]), the error will be unacceptable. We assume that for Nitrogen this percentage is 5%. For Hydrogen, Helium and other light gases, this percentage may be 10% or higher. As a demonstration, we will use 10% as a divider, below 10%, that is 5 [SLM], the thermal measurement will be used to measure the flow rate and above 10%, Coriolis measurement will be used. From the pressure drop calculation (FIG. 5), we can find out that the corresponding pressure drop of the Coriolis tube at 5 [SLM] is around 0.4 [psi]. As the both ends of thermal tube are connected with the both ends of Coriolis tube (see FIG. 3), the thermal tube will have the same pressure drop 0.4 [psi] at this time. From FIG. 6 we can see that at 0.4 [psi]pressure drop, the flow rate of the thermal tube is around 7 [sccm].

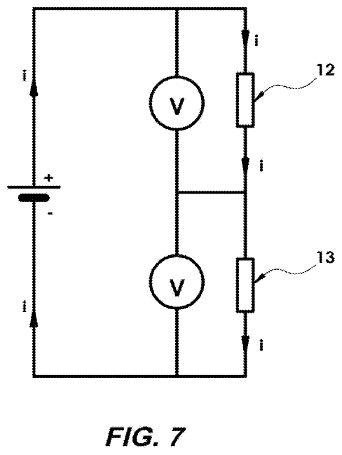

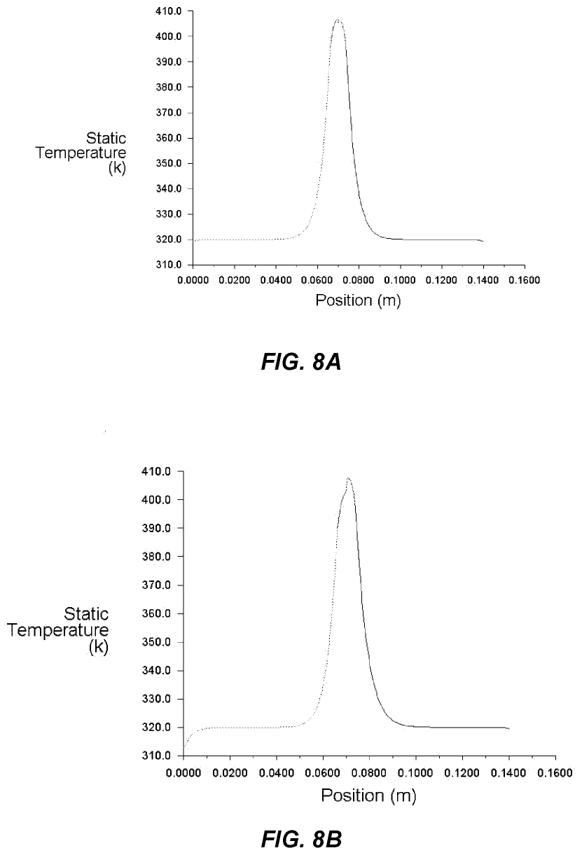

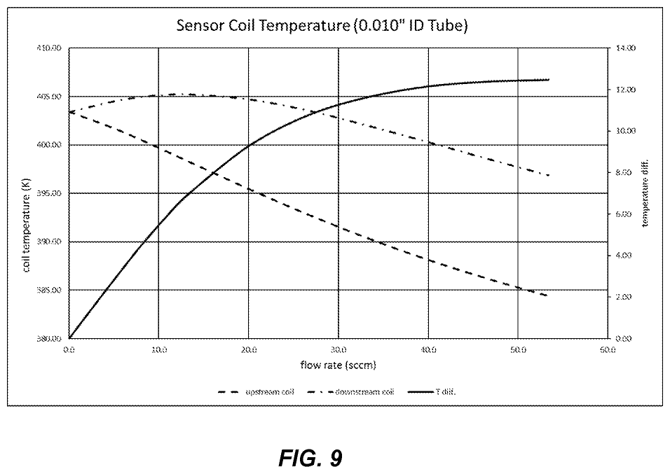

We now need to find out at 0 to 7 [sccm], what kind of output thermal sensor can provide. In the thermal measurement of the mass flow rate, coils 12 and 13 will be heated up. There are different schemes to do the heating, such as constant current, constant temperature or constant temperature drop. In this demonstration, we will use the constant current scheme as shown in FIG. 7. A constant current i is applied to both coils and kept as a constant. The temperatures of the coils will arise and change under the cooling of the flow fluid. The change is different between the upstream coil and the downstream coil. The CFD analysis results for the temperature profile of the tube wall is shown in FIGS. 8A and 8B. Without flow, as shown in FIG. 8A, the temperature reaches the peaks at the locations of coils 12 and 13. The two coils have the same temperature profiles. When there is a flow inside the tube, the cooler inlet gas will cool down upstream coil 12, and in the process, the gas will be heated up, when it reaches downstream coil 13, the temperature difference between the coil and the gas is smaller, the gas will take less heat from the coil or give heat to the coil, this will keep the temperature of downstream coil 13 higher than upstream coil 12 (FIG. 8B). This temperature changing process with the increase of the flow rate is shown in FIG. 9. The coil temperatures used are their average temperatures.

The coil temperature change will result in its resistance change:

R=R₀[(1+α(T˜T₀)], (1)

where: R and R₀ are the current and the initial coil resistances, respectively;

α is the temperature coefficient (1/K), for the resistant wire used, this value is around 0.0045;

T and T₀ are the current and the initial coil temperatures, respectively.

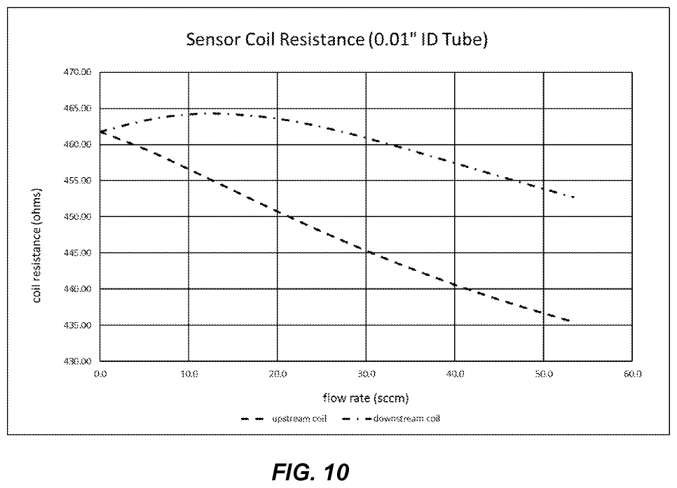

If we assume that a constant 12-mA current i is applied to both coils and we also assume that the initial resistances for both coils are 308 ohms. Based on these values and Equation (1), the coil resistance change is showing in FIG. 10.

The voltage drops V across each coil can be calculated by

V=i·R, (2)

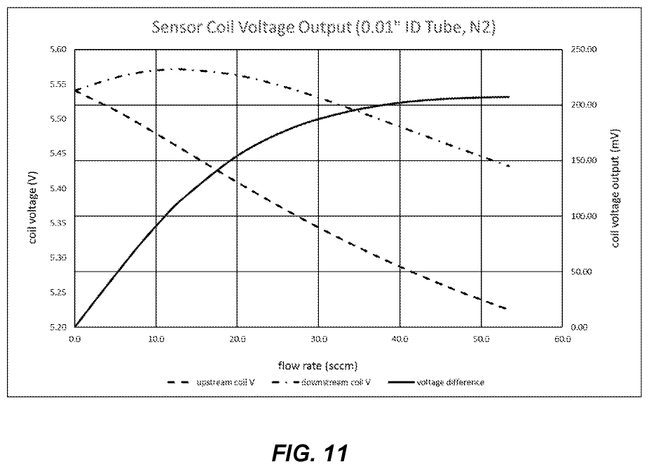

They are plotted in FIG. 11 along with the voltage difference between upstream coil 12 and downstream coil 13. The voltage difference is used as the sensor output because it cancels some nonlinearities of the voltage drops of the two coils. It can be seen that the maximum flow rate of this thermal sensor is around 40 sccm, and the sensor output at full flow rate is around 220 [mV]. In this embodiment, below 7 [sccm], the sensor output is almost a straight line, this will make the calibration easy and the error will be small. The 50 [mV] output signal is a decent signal; it will be very easy to measure with more sophisticated measuring circuit such as the one with the Wheaton Bridge.

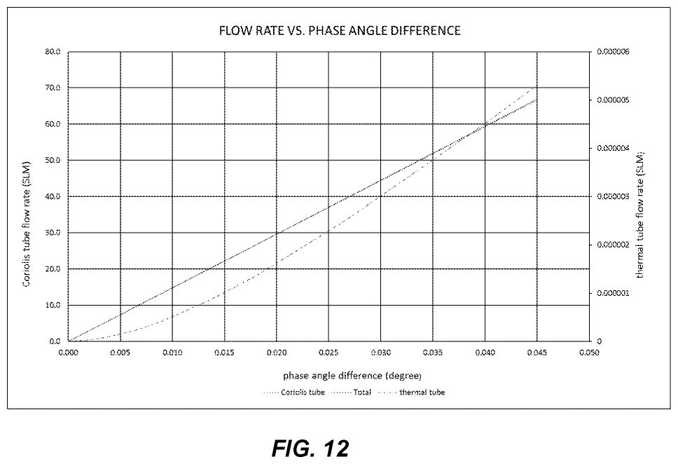

With an addition of thermal tube, the calibration is a little more complicated the one with only Coriolis tube. As shown in FIG. 12, the flow rate is a summation of both tubes. Above 10% of full flow rate, the following equation can be used:

Q_{T}=Q_{c}+Qₜ, (3)

where Q_{T}, Q_{c}, and Qₜ are the flow rates of total, Coriolis tube and thermal tube.

For the Coriolis flow, the flow rate Qₑ is a linear function of phase angle difference, that is

Q_{C}=M·φ, (4)

where φ is the phase angle difference between upstream leg and downstream leg of the sensor; and M is a constant.

For the thermal tube flow, we can use a two-order polynomial equation to fitting the curve:

Qₜ=a+b·φ+c·φ², (5)

where a, b and c are fitting coefficients.

We can combine Equations (3), (4) and (5) together as

Q_{T}=a+(M+b)·φ+c˜φ²=A+B·φ+C·φ², (6)

where constants A, B and C can be decided by the calibration and saved in the PCB RAM for the later use in operation.

It can be seen from FIG. 12 that the flow rate through the thermal tube is very small comparing with the flow rate through the Coriolis tube. In this embodiment, it is about 0.17 [SLM] verse 50 [SLM] at the full flow rate. The maximum error by ignoring the flow rate of thermal tube is 0.17/(50+0.17)=0.34%. Assuming the error for the curve fitting is 5% of 0.17 [SLM], that is 0.0085 [SLM], the error caused by the curve fitting will be 0.0085/(50+0.17)=0.016%.

Below 10% of the flow rate, we will totally rely on the thermal output. Depend on the curve linearity, different scheme can be used to interpolate the data. For the near-straight-line V-Q curve as shown in FIG. 11, during calibration, we need to find out the sensor output V_{10%} at 10% of the flow rate Q_{10%}, then the thermal section of the flow rate can be calculated by

$$Q = \frac{V}{{V}_{10 \%}} {Q}_{10 \%} . \qquad ( 7 )$$

The calibration will also decide the value φ_{10%}, that is the phase difference angle when the flow rate is 10% of the full flow. These values will be saved and retrieved during measurement. The procedure will be: first check whether the phase angle is above φ₁₀, if yes, use Equation (6) to get flow rate; if not, use Equation (7). If the thermal output is not very linear, then more sophisticated linearization and interpolation scheme should be used.

It is known that the thermal sensor is not very age-stable, that is one of the reasons that people are trying to switch to other measuring technologies or trying to recalibrate the thermal sensor in-line in recent years. With this invention, the thermal sensor output can be recalibrated easily. If it is a controller, the recalibration can be implemented per schedule, such as every 6 months, or even each power-up. For example, at each power-up or scheduled recalibration instant, the controller will control the flow rate flowing from zero up to pass the thermal-Coriolis division flow rate (10% in this demonstration), while passing the 10% flow rate Q_{10%}, the V_{10%} will be recorded down and saved in the RAM. If it is a meter, it can also be recalibrated in-line with a little help. For example, at each power up, by using manual control valve or system-controlled valve upstream of the unit to make the flow rate going up from zero to pass the Q_{10%} and record down the V_{10%}.

Thermal sensor usually has better than 1% sensitivity. For the case showing here, it means that the sensitivity is 50 [sccm], 1% of Q_{10%}, which is 5 [SLM]. The total turn-down ratio will be: 50/50,000=1:1000, an astonishing number.

As the thermal measurement is under the control of Coriolis measurement, the hybrid sensor will keep the benefit of Coriolis sensor, such as fluid insensitivity, etc.

In other embodiments, the full flow rates of the Coriolis sensor tubes can be in 10 [kg/h], 1000 [kg/h] or high flow rate levels. The diameters of the Coriolis tubes can be different with the same size of the thermal tube. From the accuracy point of view, higher flow rate units benefit more, because the flow rate of the thermal tube flow will take smaller part of the total flow. For flow rate 1000 [g/h] or less, it may lose too much accuracy due to the error caused by the thermal tube. In such case, one tube doing both Coriolis measurement and thermal measurement functions may be more suitable (in another patent). For some lighter gases, such as Hydrogen and Helium, the thinner thermal tube, such as 0.008″ ID, may be needed. For the thermal tube, instead of heating coils, MEM film sensor may be used.

What is claimed is:

1. A hybrid mass flow sensor comprising:
a Coriolis tube;
a thermal tube;
a base plate in which the Coriolis tube and thermal tube are installed airtightly;
a pair of resistant coils wound on the thermal tube;
a magnetic disk attached to the Coriolis tube;
an excitation coil installed close to the magnetic disk without contact;
a pair of optical sensors surrounding portions of the Coriolis tube without contact, and
a PCB mounted on the base plate and anchoring the optical sensors and the excitation coil.

2. The hybrid mass flow sensor of claim 1 which has both Coriolis tube and thermal tube.

3. The hybrid mass flow sensor of claim 1 wherein the Coriolis tube and thermal are installed parallelly and share the same inlet and outlet.

4. The hybrid mass flow sensor of claim 1 wherein the Coriolis tube measures the high-end mass flow rate of the fluid by the Coriolis principle.

5. The hybrid mass flow sensor of claim 1 wherein the thermal tube measures the low-end mass flow rate of the fluid by the thermal principle.

6. The hybrid mass flow sensor of claim 1 wherein the total flow rate is the summation of the flow rates of the Coriolis tube and the thermal tube.

7. The hybrid mass flow sensor of claim 1 wherein the resistant coils on the thermal tube are covered by covers to create a mini stable environment around the resistant coils.

8. The hybrid mass flow sensor of claim 1 wherein the resistant coils are optionally replaced by the flexible film resistant elements or thermal sensitive chips.

9. The hybrid mass flow sensor of claim 1 wherein the excitation coil will excite the Coriolis tube by applying magnetic force on the magnetic disk and make the flow tube doing swing motion.

10. The hybrid mass flow sensor of claim 1 wherein the optical sensors will monitor the twist motion of the Coriolis tube produced by the Coriolis force caused by the medium flowing inside the Coriolis tube.

11. The hybrid mass flow sensor of claim 1 wherein the sensor PCB, firmware and software will treat the signals acquired by the optical sensors and convert them to the mass flow rate.

12. The hybrid mass flow sensor of claim 1 wherein the thermal measurement will be calibrated by the Coriolis measurement.
